(19) United States
(12) Patent Application Publication
(10) Pub. No.: US 2024/0038108 A1
(43) Pub. Date: Feb. 1, 2024

(54) IMAGE DISPLAY APPARATUS, IMAGE DISPLAY METHOD, AND PROGRAM

(71) Applicant: SONY GROUP CORPORATION, Tokyo (JP)

(72) Inventors: Ippei TAMBATA, Tokyo (JP); Kohki WATANABE, Tokyo (JP)

(73) Assignee: SONY GROUP CORPORATION, Tokyo (JP)

(21) Appl. No.: 18/256,182

(22) PCT Filed: Nov. 16, 2021
(86) PCT No.: PCT/JP2021/042045

§ 371 Date: Jun. 6, 2023

(30) Foreign Application Priority Data
Dec. 18, 2020 (JP) 2020-209843

(51) Int. Cl. G09G 3/00; H04N 13/363; H04N 13/366; H04N 13/122

(52) U.S. Cl. CPC G09G 3/003; G09G 3/03; H04N 13/363; H04N 13/366; H04N 13/122; G09G 2354/00; G09G 2340/0407; G09G 2340/12; G09G 2320/0686; G09G 2320/0626

(57) ABSTRACT

It is an object of the present technology to provide an image display apparatus, an image display method, and a program that make it possible to provide a high-quality viewing experience. In order to achieve the object described above, an image display apparatus according to an embodiment of the present technology includes a screen and a display section. The screen is a cylindrical screen that extends in parallel with a specified axis. The display section causes a surface image and a primary-display image to overlap, the surface image being displayed on a substantial entirety of a surface of the screen, the primary-display image being displayed to look as if the primary-display image were situated in an internal space of the screen. This makes it possible to provide a high-quality viewing experience.

### TECHNICAL FIELD

The present technology relates to an image display apparatus that displays an image.

### BACKGROUND ART

Patent Literature 1 discloses an image display apparatus that includes a display section that includes a first screen and a second screen, and another display section that projects a first image and a second image. The first screen is curved. The second screen is transparent and is arranged in front of the first screen to be spaced from the first screen. The other display section projects the first image onto the first screen, and projects the second image onto the second screen. Accordingly, the images are respectively displayed on the two curved surfaces in a state in which the images overlap. This results in performing, at a wider viewing angle, image display that produces a sense of depth (for example, paragraphs to of the specification and FIG. 1 in Patent Literature 1).

### CITATION LIST

### Patent Literature

Patent Literature 1: WO 2020/080111

### DISCLOSURE OF INVENTION

### Technical Problem

There is a need for a technology that makes it possible to precisely recognize a positional relationship between images respectively displayed on screens, and to provide a high-quality viewing experience, as described above.

In view of the circumstances described above, it is an object of the present technology to provide an image display apparatus, an image display method, and a program that make it possible to provide a high-quality viewing experience.

### Solution to Problem

In order to achieve the object described above, an image display apparatus according to an embodiment of the present technology includes a screen and a display section.

The screen is a cylindrical screen that extends in parallel with a specified axis.

The display section causes a surface image and a primary-display image to overlap, the surface image being displayed on a substantial entirety of a surface of the screen, the primary-display image being displayed to look as if the primary-display image were situated in an internal space of the screen.

In the image display apparatus, a surface image that is displayed on a substantial entirety of a surface of a cylindrical screen that extends in parallel with a specified axis, and a primary-display image that is displayed to look as if the primary-display image were situated in an internal space of the screen overlap. This makes it possible to provide a high-quality viewing experience.

The image display apparatus may further include an image controller that controls the primary-display image on the basis of surrounding information including position information regarding a position of a viewer.

The surrounding information may include ambient light that is situated in surroundings of the screen.

On the basis of a position of the ambient light, the image controller may perform control such that a shadow overlaps the primary-display image.

The display section may display the primary-display image on the basis of the position information.

The image display apparatus may further include a generator that generates the surface image and the primary-display image.

The generator may generate the primary-display image from a 3D object on the basis of the position information regarding a position of a viewer.

The generator may generate the surface image from a planar image on the basis of a form of the screen.

The image controller may control the surface image on the basis of a position of the ambient light.

On the basis of the position of the viewer and a position of the surface image displayed on the screen, the image controller performs control such that a resolution of a portion of the surface image that is projected onto a region of the screen that is situated away from the viewer, is made lower than a resolution of another portion of the surface image that is projected onto another region of the screen that is situated close to the viewer.

An image display method according to an embodiment of the present technology is an image display method that is performed by a computer system, the image display method including causing a surface image and a primary-display image to overlap, the surface image being displayed on a substantial entirety of a surface of a cylindrical screen that extends in parallel with a specified axis, the primary-display image being displayed to look as if the primary-display image were situated in an internal space of the screen.

A program according to an embodiment of the present technology causes a computer system to perform a process including causing a surface image and a primary-display image to overlap, the surface image being displayed on a substantial entirety of a surface of a cylindrical screen that extends in parallel with a specified axis, the primary-display image being displayed to look as if the primary-display image were situated in an internal space of the screen.

### BRIEF DESCRIPTION OF DRAWINGS

FIG. 1 schematically illustrates an image display apparatus.

FIG. 2 schematically illustrates an example of displaying a primary-display image.

FIG. 3 is a block diagram illustrating an example of a configuration of the image display apparatus.

FIG. 4 is a flowchart illustrating a method for displaying a display image and a primary-display image.

FIG. 5 is a flowchart illustrating a method for displaying a display image and a primary-display image.

FIG. 6 schematically illustrates an example of image control performed on a display image and a primary-display image.

FIG. 7 schematically illustrates an example of controlling a display image.

FIG. 8 is a block diagram illustrating an example of a configuration of hardware of the image display apparatus.

### MODE(S) FOR CARRYING OUT THE INVENTION

Embodiments according to the present technology will now be described below with reference to the drawings.

### First Embodiment

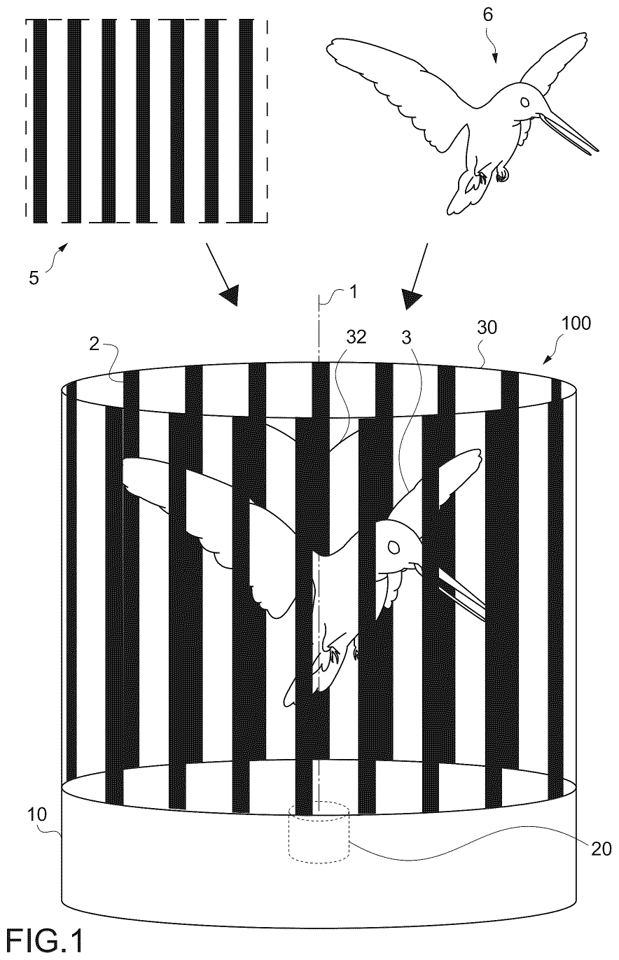

FIG. 1 schematically illustrates an image display apparatus according to a first embodiment of the present technology.

As illustrated in FIG. 1, an image display apparatus 100 includes a base 10, a display section 20, and a screen 30.

The base 10 is in the form of a cylinder, and is provided to a lower portion of the image display apparatus 100. The base 10 holds the display section 20, the screen 30, and a reflective mirror 32 using any holding mechanism (not illustrated). Further, a power-supply source such as a battery (not illustrated), a speaker, an element that is necessary to operate the image display apparatus 100, and the like are provided to the base 10 as necessary. The form and the like of the base 10 are not limited, and any form such as a form of a rectangular parallelepiped may be used.

The display section 20 is arranged at substantially the center of the cylindrical base 10 to be oriented upward. In parallel with a vertically extending optical axis 1, the display section emits image light that makes up an image. In the present embodiment, the optical axis 1 corresponds to a specified axis.

For example, a laser-scanning color projector that scans pieces of laser light respectively corresponding to colors of red, green, and blue to display each pixel, is used as the display section 20. A specific configuration of the display section 20 is not limited, and, for example, a small mobile projector (a picoprojector) or a projector using laser light of one color may be used as appropriate according to, for example, the size or the application of the image display apparatus 100. Any other projectors that can project image light may be used.

The screen 30 is in the form of a cylinder, and is arranged all about the optical axis 1. In the present embodiment, the screen 30 is provided such that a central axis of the (cylindrical) screen 30 and the optical axis 1 of the display section 20 substantially coincide. In the example illustrated in FIG. 1, the screen 30 having a diameter equal to a diameter of the base 10 is provided. Without being limited thereto, the diameter, the height, and the like of the screen 30 may be set as appropriate.

The screen 30 is a transmissive hologram that is arranged all about the optical axis 1. The transmissive hologram records therein, for example, interference fringes due to light diffused by a diffusion plate, and includes a diffusion function of diffusing incident image light. Without being limited thereto, a light diffusion layer or the like that diffuses image light, and a transmissive hologram that does not include a diffusion function may be arranged in a layered formation in a state in which the light diffusion layer or the like is situated on the outside of the transmissive hologram (on a side opposite to a side of the optical axis 1). In the present embodiment, the screen 30 serves as a hologram screen.

The image light incident from the inside of the transmissive hologram is diffused (scattered) by the transmissive hologram in various directions to exit the transmissive hologram.

A specific configuration of the screen 30 is not limited, and, for example, a screen that uses scatterers such as fine particles or a microlens to diffuse light may be used as appropriate. Moreover, for example, any film or coating that can diffuse image light may be used as a transmissive screen.

In the present embodiment, the display section 20 displays a surface image 2 and a primary-display image 3 on the screen 30, as illustrated in FIG. 1.

The surface image is an image that looks to a viewer (a user) as if the image were situated on the surface of the screen 30. For example, black lines 2 are displayed as bars of a birdcage in FIG. 1. In the present embodiment, the surface image is displayed on a substantial entirety of the screen 30.

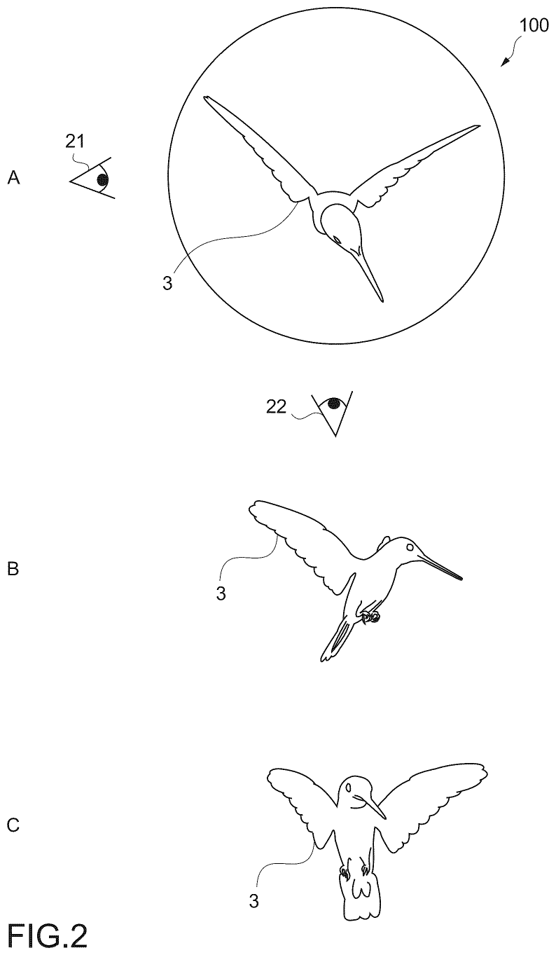

The primary-display image is an image that looks to the viewer as if the image were situated inside of the screen 30. For example, a flying bird 3 is displayed inside of the bars of the birdcage in FIG. 1. Further, in the present embodiment, the primary-display image is displayed by the display section 20 on the basis of position information regarding a position of the viewer. A specific example will be described with reference to FIG. 2.

Note that the substantial entirety corresponds to an amount sufficient to provide a more excellent parallax effect for the surface of the screen 30 and the inside of the screen 30 (a cylinder) when the surface image 2 and the primary-display image 3 overlap, and to cause the viewer to recognize a positional relationship between images (objects) that are separately situated on the surface of the screen 30 and inside of the screen 30. In other words, the surface image 2 is not limited to occupying a specified percentage of the surface area of the screen 30.

In the present embodiment, the surface image 2 is generated from a planar image 5. Specifically, the surface image 2 is generated from the planar image 5 by a surface image generator 11 described later, on the basis of a form of the screen 30.

Further, the primary-display image 3 is generated from a virtual 3D object 6. The virtual 3D object is an object obtained by capturing an image of an object horizontally and vertically from all directions of 360 degrees. Specifically, the primary-display image 3 is generated from the virtual 3D object 6 by a primary-display image generator 13 described later, on the basis of position information regarding a position of a viewer (such as a point of view). In other words, a primary-display image is an image displayed when a virtual 3D object is viewed on the basis of position information regarding a position of a viewer.

In other words, the image display apparatus 100 controls the planar image 5 and the virtual 3D object 6 on the basis of the form of the screen 30 and position information regarding a position of a viewer, and displays the surface image 2 and the primary-display image 3 in a state in which the surface image 2 and the primary-display image 3 overlap.

FIG. 2 schematically illustrates an example of displaying a primary-display image. A of FIG. 2 schematically illustrates the primary-display image as viewed by a viewer from above the screen 30 (for example, in parallel with the optical axis 1).

As illustrated in A of FIG. 2, the bird 3 corresponding to a primary-display image as viewed from above is displayed when the viewer views the image display apparatus 100 in parallel with the optical axis 1. For example, position information regarding a position of the viewer is acquired by a surrounding information acquiring section 12 described later, and a primary-display image is displayed on the basis of the position information.

Regarding B of FIG. 2, when the position information regarding a position of the viewer (a point of view 21) indicates a position immediately lateral to the screen 30, a primary-display image obtained when the bird 3 is laterally viewed is displayed, as illustrated in B of FIG. 2.

Likewise, regarding C of FIG. 2, when the position information regarding a position of the viewer (a point of view 22) indicates a position in front of the screen 30, a primary-display image obtained when the bird 3 is viewed in front is displayed, as illustrated in C of FIG. 2.

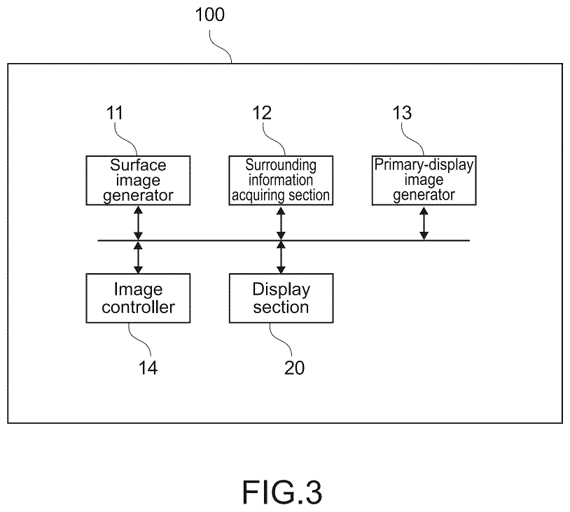

FIG. 3 is a block diagram illustrating an example of a configuration of the image display apparatus illustrated in FIG. 1.

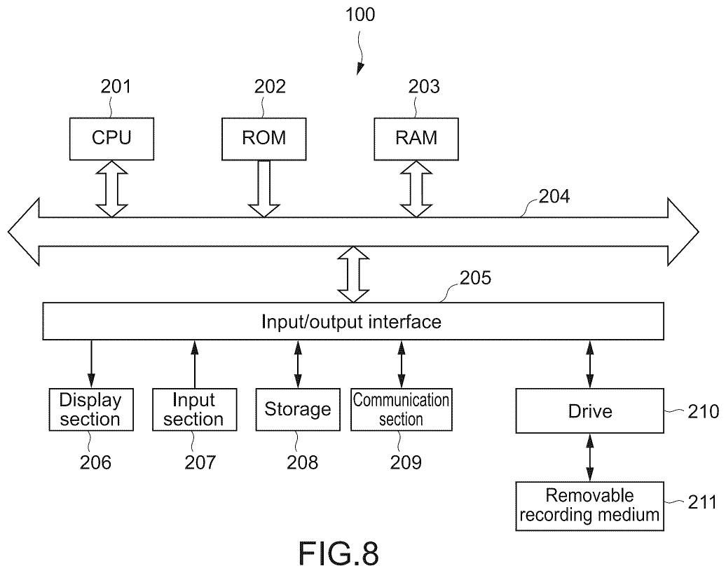

The image display apparatus 100 includes hardware, such as a processor such as a CPU, a GPU, and a DSP; a memory such as a ROM and a RAM; and a storage device such as an HDD, that is necessary for a configuration of a computer (refer to FIG. 8). For example, an image display method according to the present technology is performed by, for example, the CPU loading, into the RAM, a program according to the present technology that is recorded in, for example, the ROM in advance and executing the program.

For example, the image display apparatus 100 can be implemented by any computer such as a PC. Of course, hardware such as an FPGA or an ASIC may be used.

In the present embodiment, a display section is implemented as a functional block by the CPU executing a specified program. Of course, dedicated hardware such as an integrated circuit (IC) may be used in order to implement the functional block.

The program is installed on the image display apparatus 100 through, for example, various recording media. Alternatively, the installation of the program may be performed via, for example, the Internet.

The type and the like of a recording medium that records therein a program are not limited, and any computer-readable recording medium may be used. For example, any non-transitory computer-readable recording medium may be used.

As illustrated in FIG. 3, the image display apparatus 100 includes the surface image generator 11, the surrounding information acquiring section 12, the primary-display image generator 13, an image controller 14, and the display section 20.

The surface image generator 11 generates a surface image. In the present embodiment, the surface image generator 11 generates a surface image formed along a physical form of the screen 30. When, for example, the screen 30 is in the form of a cylinder, as illustrated in FIG. 1, the surface image generator 11 generates a surface image obtained by a planar image being deformed along (being attached to) the surface of the cylinder. Further, the surface image generator 11 generates the surface image on the basis of position information regarding a position of a viewer that is acquired by the surrounding information acquiring section 12.

Furthermore, in the present embodiment, the surface image generated by the surface image generator 11 is supplied to the image controller 14 and the display section 20.

The surrounding information acquiring section 12 acquires surrounding information regarding surroundings of the image display apparatus 100.

Examples of the surrounding information include position information regarding a position of a viewer and position information regarding a position of ambient light. For example, the position information regarding a position of a viewer is information that indicates at which position (from which point of view) relative to the image display apparatus 100 the viewer is viewing the screen 30. Specifically, a viewer is tracked by, for example, a tracker or a camera, and a position of a face of or positions of eyes of the viewer, a direction in which the viewer is looking, or the like is recognized using, for example, image recognition. Accordingly, the position information regarding a position of a viewer is acquired.

Examples of the ambient light include light coming from a light source that is situated in the surroundings of the image display apparatus 100, and light that is projected by the display section 20. Moreover, the examples of the ambient light also include light coming from a virtual light source that is set up by, for example, a viewer.

Note that, in addition to what is described above, the examples of the surrounding information may also include an amount of light of a light source, a color of the light source, and the brightness in the surroundings.

In the present embodiment, the surrounding information acquired by the surrounding information acquiring section 12 is supplied to the surface image generator 11, the primary-display image generator 13, and the image controller 14.

Note that a method for acquiring the surrounding information is not limited. For example, the surrounding information may be acquired by any type of sensor, or may be input by a viewer.

The primary-display image generator 13 generates a primary-display image. In the present embodiment, the primary-display image generator 13 generates a primary-display image on the basis of position information regarding a position of a viewer that is acquired by the surrounding information acquiring section 12.

In the present embodiment, the primary-display image generated by the primary-display image generator 13 is supplied to the image controller 14 and the display section 20.

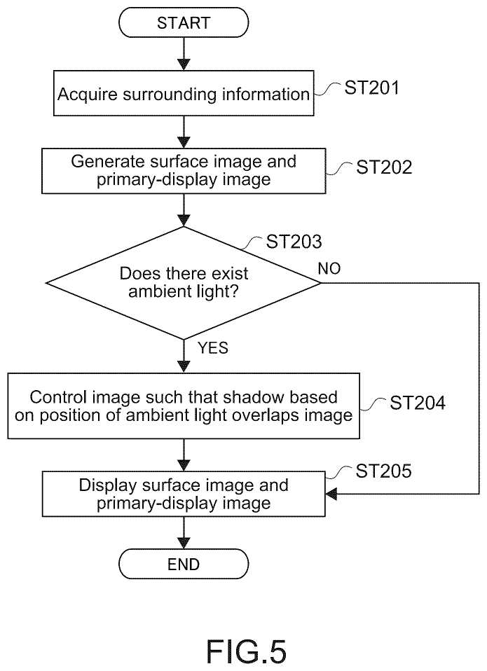

The image controller 14 controls at least one of a surface image or a primary-display image. In the present embodiment, the image controller 14 controls the primary-display image on the basis of surrounding information. For example, the image controller 14 causes a shadow to overlap the primary-display image on the basis of a position of ambient light (refer to A of FIG. 5).

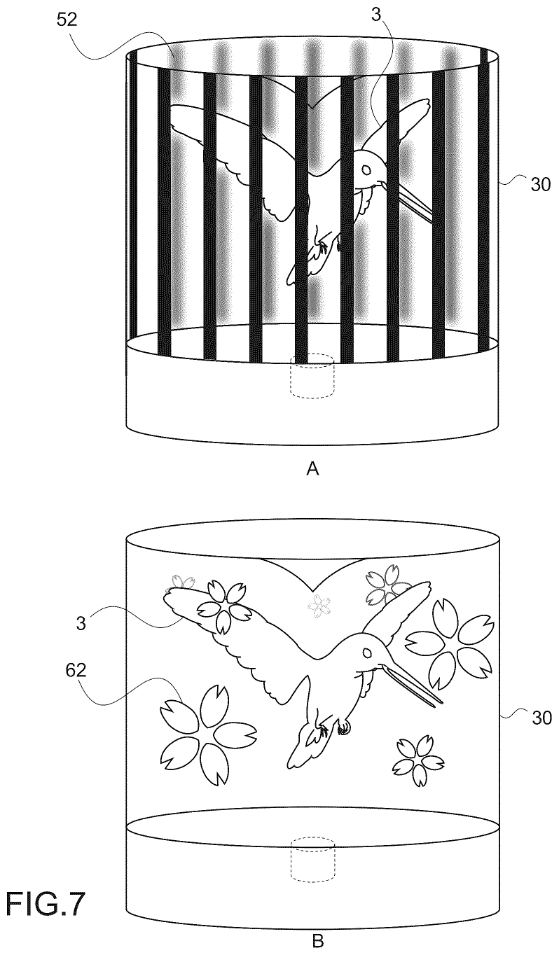

Further, the image controller 14 controls the surface image on the basis of surrounding information. For example, the image controller 14 reduces a resolution of a portion of the surface image on the basis of position information regarding a position of a viewer, the portion of the surface image being displayed on a side situated opposite to a side of the viewer relative to the optical axis 1 (refer to A of FIG. 7).

Furthermore, in the present embodiment, the surface image and the primary-display image that are controlled by the image controller 14 are supplied to the display section 20.

The display section 20 displays the surface image and the primary-display image on the screen 30 in a state in which the surface image and the primary-display image overlap. In the present embodiment, a surface image that is generated by the surface image generator 11 and formed along the form of the screen 30, and a primary-display image that is generated by the primary-display image generator 13 on the basis of position information regarding a position of a viewer are caused to overlap, and are displayed on the screen 30.

Note that, in the present embodiment, the surface image generator 11 and the primary-display image generator 13 serve as a generator that generates a surface image and a primary-display image.

Note that, in the present embodiment, the image controller 14 corresponds to an image controller that controls a primary-display image on the basis of surrounding information including position information regarding a position of a viewer.

Note that, in the present embodiment, the display section 20 corresponds to a display section that causes a surface image and a primary-display image to overlap, the surface image being displayed on a substantial entirety of the surface of a screen, the primary-display image being displayed to look as if the primary-display image were situated in an internal space of the screen.

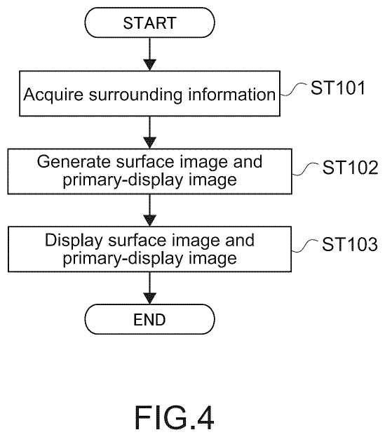

FIG. 4 is a flowchart illustrating a method for displaying a display image and a primary-display image. Note that, in the first embodiment, ambient light situated around the image display apparatus 100 is not taken into consideration.

The surrounding information acquiring section 12 acquires surrounding information regarding surroundings of the image display apparatus 100 (Step 101). In the present embodiment, the surrounding information acquiring section 12 acquires position information regarding a position of a viewer.

The surface image generator 11 generates a surface image formed along the form of the screen 30. Further, the primary-display image generator 13 generates a primary-display image on the basis of the position information regarding a position of a viewer (Step 102).

The display section 20 displays, on the screen, the surface image and the primary-display image that are respectively generated by the surface image generator 11 and the primary-display image generator 13 (Step 103).

As described above, in the image display apparatus 100 according to the present embodiment, the surface image 2 displayed on a substantial entirety of the surface of the cylindrical screen extending in parallel with the optical axis 1, and the primary-display image 3 displayed to look as if the primary-display image 3 were situated in an internal space of the screen 30 overlap. This makes it possible to provide a high-quality viewing experience.

When a video is projected onto the surface of a transparent screen in the form of a cylinder and a stereoscopic video is intended to be displayed, an object in the displayed video conventionally looks as if the object were situated on the surface of the screen and also looks as if the object were situated inside of the cylinder. This results in difficulty in providing a stereoscopic effect stably. Further, there is a need for a viewer to recognize at which position in the cylinder an object to be displayed inside of the cylinder is arranged, in order to give a three-dimensional appearance to the object.

In the present technology, two objects that are an object (a surface image) that is situated on a substantial entirety of the surface of a cylinder (a screen) and an object (a primary-display image) that is situated inside of the cylinder are generated separately, and are caused to overlap to be displayed. Further, regarding the surface image, a video is generated to be displayed at a viewing angle conforming to the surface of the cylinder. Regarding the primary-display image, a video from a point of view conforming to a position of a viewer is generated to be displayed.

The surface image helps a viewer recognize an existing screen and an internal space of the screen. A more excellent parallax effect for the surface of a space and the inside of the space is provided by two videos being caused to overlap and being displayed. Further, it is possible to cause a viewer to recognize a positional relationship between objects that are separately situated on the surface of the screen 30 and inside of the screen 30. Furthermore, this makes it possible to stably obtain a visual effect that enables an object to look as if the object were situated inside of a cylinder.

Further, position information regarding a position of a viewer is reflected only in a primary-display image in real time, and this makes it possible to exaggerate a movement parallax relative to an object displayed on the surface. This results in being able to raise awareness of a stereoscopic effect. Furthermore, the movement parallax is further exaggerated by an object that is displayed on the surface and formed along a physical form being used in combination with a primary-display image.

### Second Embodiment

An image display apparatus according to a second embodiment of the present technology is described. In the following description, descriptions of a configuration and an operation that are similar to those of the image display apparatus 100 described in the embodiment above are omitted or simplified.

In the embodiment described above, a surface image and a primary-display image are displayed without taking into consideration a position of ambient light that is surrounding information. In the second embodiment, the image controller 14 performs image control on the basis of position information regarding a position of ambient light. This makes it possible to raise awareness of arrangement of a primary-display image inside of a screen.

FIG. 5 is a flowchart illustrating a method for displaying a display image and a primary-display image according to the second embodiment.

The surrounding information acquiring section 12 acquires surrounding information regarding surroundings of the image display apparatus 100 (Step 201). In the present embodiment, the surrounding information acquiring section 12 acquires position information regarding a position of a viewer and position information regarding a position of ambient light. The surface image generator 11 generates a surface image formed along the form of the screen 30. Further, the primary-display image generator 13 generates a primary-display image on the basis of the position information regarding a position of a viewer (Step 202).

When the surrounding information acquiring section 12 acquires the position information regarding a position of ambient light (YES in Step 203), the image controller 14 causes a shadow based on the position of the ambient light to overlap the primary-display image (Step 204).

The display section 20 displays, on the screen 30, the surface image and the primary-display image on which image control has been performed by the image controller 14 (Step 205). Note that, when surrounding information related to the ambient light is not acquired (NO in Step 203), the surface image and the primary-display image are displayed on the screen 30 as in the first embodiment.

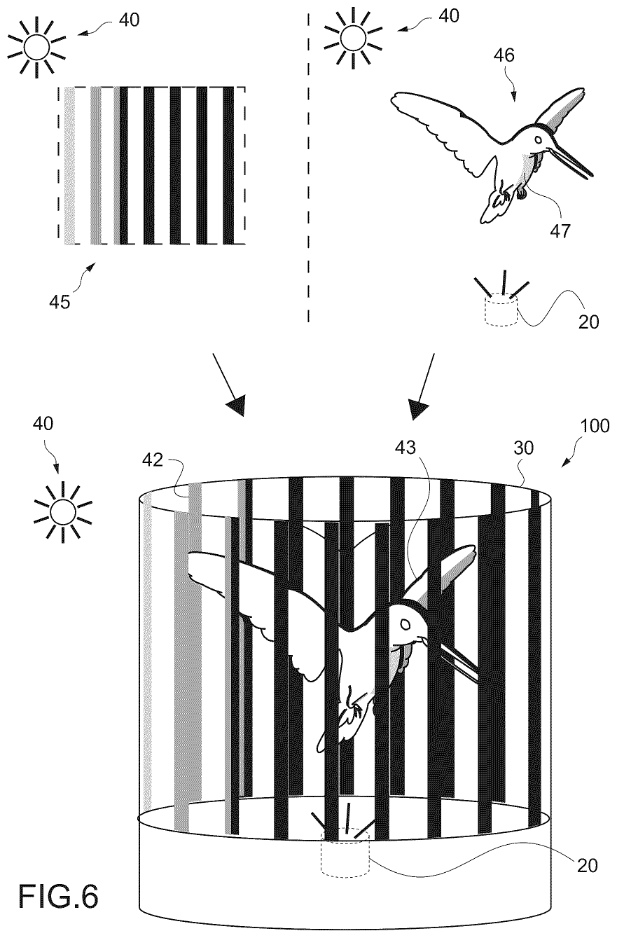

FIG. 6 schematically illustrates an example of image control performed on a display image and a primary-display image. Note that FIG. 6 illustrates image control related to the surface image and a shadow of the primary-display image. Without being limited thereto, the image controller 14 may control the brightness of the surface image and the brightness of the primary-display image on the basis of a position of ambient light and an amount of the ambient light.

In the present embodiment, the surrounding information acquiring section 12 acquires surrounding information related to a virtual light source 40 and surrounding information related to the display section 20, as illustrated in FIG. 6.

The image controller 14 reflects, in a planar image used as the surface image, the brightness obtained due to ambient light emitted by the virtual light source 40. Specifically, the image controller 14 controls the brightness of the planar image according to the brightness of the ambient light. The surface image generator 11 generates, as a surface image 42, a planar image 45 in which the brightness has been reflected.

Further, the image controller 14 causes a shadow 47 to overlap a virtual 3D object 46, the shadow 47 being generated due to pieces of ambient light respectively emitted by the virtual light source 40 and the display section 20. Specifically, the image controller 14 controls the brightness of a primary-display image according to the brightness of the ambient light. The primary-display image generator 13 generates a primary-display image 43 that a shadow overlaps, on the basis of position information regarding a position of a viewer.

In the present embodiment, the image controller 14 performs image control on the primary-display image 43 on the basis of where the primary-display image is displayed. For example, the overlapping shadow is controlled according to whether the virtual light source 40 exists at a low or high position relative to a height of a bird (the primary-display image 43) situated inside of the screen 30. Specifically, the position of a shadow that overlaps a bird is changed.

Note that image control performed by the image controller 14 is not limited. For example, a shadow thickness may be controlled according to an amount of light of a light source, or a color may be added to the primary-display image 43 according to a color of the light source. FIG. 7 schematically illustrates an example of controlling a display image.

The image controller 14 may perform not only the image control based on ambient light, as illustrated in FIG. 6, but also any kinds of image control. For example, in FIG. 7, the image controller 14 performs image control on the basis of position information regarding a position of a viewer.

In A of FIG. 7, display is performed such that a portion of a surface image 52 displayed on the screen 30 is blurred. Specifically, the image controller 14 performs control to reduce a resolution of a portion of the surface image 52 on the basis of position information regarding a position of a viewer that is acquired by the surrounding information acquiring section 12, the portion of the surface image 52 being displayed on a region of the screen 30 that is situated away from a viewer. In other words, image control is performed such that a background (an image displayed in back) of the primary-display image 3 (the bird) looks blurred when the viewer views the screen 30 directly from the side.

In B of FIG. 7, the size of a surface image 62 (a flower) that is displayed on the screen 30 is controlled. For example, when the bird 3 is flying around in a cylinder (the screen 30), the flower 62 displayed in front of the bird 3 (between the primary-display image and a viewer) is displayed in a large size, or the flower 62 displayed behind the bird 3 is displayed in a small size or displayed at a reduced resolution.

Those kinds of image control make it possible to raise awareness of a position of a primary-display image from the center of the screen 30.

FIG. 8 is a block diagram illustrating an example of a configuration of hardware of the image display apparatus 100.

The image display apparatus 100 includes a CPU 201, a ROM 202, a RAM 203, an input/output interface 205, and a bus 204 through which these components are connected to each other. A display section 206, an input section 207, a storage 208, a communication section 209, a drive 210, and the like are connected to the input/output interface 205.

The display section 206 is a display device using, for example, liquid crystal or EL. Examples of the input section 207 include a keyboard, a pointing device, a touch panel, and other operation apparatuses. When the input section 207 includes a touch panel, the touch panel may be integrated with the display section 206.

The storage 208 is a nonvolatile storage device, and examples of the storage 208 include an HDD, a flash memory, and other solid-state memories. The drive 210 is a device that can drive a removable recording medium 211 such as an optical recording medium, a magnetic recording tape, or the like.

The communication section 209 is a modem, a router, or another communication apparatus that can be connected to, for example, a LAN or a WAN and is used to communicate with another device. The communication section 209 may perform communication wirelessly or by wire. The communication section 209 is often used in a state of being separate from the image display apparatus 100.

Information processing performed by the image display apparatus 100 having the configuration of hardware described above is performed by software stored in, for example, the storage 208 or the ROM 202, and hardware resources of the image display apparatus 100 working cooperatively. Specifically, the information processing method according to the present technology is performed by loading, into the RAM 203, a program included in the software and stored in the ROM 202 or the like and executing the program.

For example, the program is installed on the image display apparatus 100 through the recording medium 211. Alternatively, the program may be installed on the image display apparatus 100 through, for example, a global network. Moreover, any non-transitory computer-readable storage medium may be used.

The image display method and the program according to the present technology may be executed and the image display apparatus according to the present technology may be implemented by a computer included in a communication terminal and another computer working cooperatively, the other computer being capable of communicating with the computer through, for example, a network.

In other words, the image display apparatus, the image display method, and the program according to the present technology can be executed not only in a computer system that includes a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the image display apparatus, the image display method, and the program according to the present technology by the computer system includes, for example, both the case in which the recognition performed by a viewer, the generation of a primary-display image, the image control, and the like are executed by a single computer; and the case in which the respective processes are executed by different computers. Further, the execution of each process by a specified computer includes causing another computer to execute a portion of or all of the process and acquiring a result of it.

In other words, the image display apparatus, the image display method, and the program according to the present technology are also applicable to a configuration of cloud computing in which a single function is shared and cooperatively processed by a plurality of apparatuses through a network.

The respective configurations of the display image generator, the primary-display image generator, the image controller, and the like; the flow of controlling a communication system; and the like described with reference to the respective figures are merely embodiments, and any modifications may be made thereto without departing from the spirit of the present technology. In other words, for example, any other configurations or algorithms for purpose of practicing the present technology may be adopted.

Note that the effects described in the present disclosure are not limitative but are merely illustrative, and other effects may be provided. The above-described description of the plurality of effects does not necessarily mean that the plurality of effects is provided at the same time. The above-described description means that at least one of the effects described above is provided depending on, for example, a condition. Of course, there is a possibility that an effect that is not described in the present disclosure will be provided.

At least two of the features of the present technology described above can also be combined. In other words, the various features described in the respective embodiments may be combined discretionarily regardless of the embodiments.

Note that the present technology may also take the following configurations.
(1) An image display apparatus, including:
   a cylindrical screen that extends in parallel with a specified axis; and
   a display section that causes a surface image and a primary-display image to overlap, the surface image being displayed on a substantial entirety of a surface of the screen, the primary-display image being displayed to look as if the primary-display image were situated in an internal space of the screen.
(2) The image display apparatus according to (1), further including
   an image controller that controls the primary-display image on the basis of surrounding information including position information regarding a position of a viewer.
(3) The image display apparatus according to (2), in which
   the surrounding information includes ambient light that is situated in surroundings of the screen.
(4) The image display apparatus according to (3), in which
   on the basis of a position of the ambient light, the image controller performs control such that a shadow overlaps the primary-display image.
(5) The image display apparatus according to (2), in which
   the display section displays the primary-display image on the basis of the position information.
(6) The image display apparatus according to (1), further including
   a generator that generates the surface image and the primary-display image.
(7) The image display apparatus according to (6), in which
   the generator generates the primary-display image from a 3D object on the basis of the position information regarding a position of a viewer.
(8) The image display apparatus according to (6), in which
   the generator generates the surface image from a planar image on the basis of a form of the screen.
(9) The image display apparatus according to (3), in which
   the image controller controls the surface image on the basis of a position of the ambient light.
(10) The image display apparatus according to (2), in which
   on the basis of the position of the viewer and a position of the surface image displayed on the screen, the image controller performs control such that a resolution of a portion of the surface image that is projected onto a region of the screen that is situated away from the viewer, is made lower than a resolution of another portion of the surface image that is projected onto another region of the screen that is situated close to the viewer.
(11) An image display method that is performed by a computer system, the image display method including
   causing a surface image and a primary-display image to overlap, the surface image being displayed on a substantial entirety of a surface of a cylindrical screen that extends in parallel with a specified axis, the primary-display image being displayed to look as if the primary-display image were situated in an internal space of the screen.
(12) A program that causes a computer system to perform a process including
   causing a surface image and a primary-display image to overlap, the surface image being displayed on a substantial entirety of a surface of a cylindrical screen that extends in parallel with a specified axis, the primary-display image being displayed to look as if the primary-display image were situated in an internal space of the screen.

### REFERENCE SIGNS LIST

1 optical axis
2 surface image
3 primary-display image
11 surface image generator
13 primary-display image generator
14 image controller
20 display section
100 image display apparatus

What is claimed is:

1. An image display apparatus, comprising:
a cylindrical screen that extends in parallel with a specified axis; and
a display section that causes a surface image and a primary-display image to overlap, the surface image being displayed on a substantial entirety of a surface of the screen, the primary-display image being displayed to look as if the primary-display image were situated in an internal space of the screen.

2. The image display apparatus according to claim 1, further comprising
an image controller that controls the primary-display image on a basis of surrounding information including position information regarding a position of a viewer.

3. The image display apparatus according to claim 2, wherein
the surrounding information includes ambient light that is situated in surroundings of the screen.

4. The image display apparatus according to claim 3, wherein
on a basis of a position of the ambient light, the image controller performs control such that a shadow overlaps the primary-display image.

5. The image display apparatus according to claim 2, wherein
the display section displays the primary-display image on a basis of the position information.

6. The image display apparatus according to claim 1, further comprising
a generator that generates the surface image and the primary-display image.

7. The image display apparatus according to claim 6, wherein
The generator generates the primary-display image from a 3D object on a basis of the position information regarding a position of a viewer.

8. The image display apparatus according to claim 6, wherein
the generator generates the surface image from a planar image on a basis of a form of the screen.

9. The image display apparatus according to claim 3, wherein
the image controller controls the surface image on a basis of a position of the ambient light.

10. The image display apparatus according to claim 2, wherein
on a basis of the position of the viewer and a position of the surface image displayed on the screen, the image controller performs control such that a resolution of a portion of the surface image that is projected onto a region of the screen that is situated away from the viewer, is made lower than a resolution of another portion of the surface image that is projected onto another region of the screen that is situated close to the viewer.

11. An image display method that is performed by a computer system, the image display method comprising
causing a surface image and a primary-display image to overlap, the surface image being displayed on a substantial entirety of a surface of a cylindrical screen that extends in parallel with a specified axis, the primary-display image being displayed to look as if the primary-display image were situated in an internal space of the screen.

12. A program that causes a computer system to perform a process, comprising
causing a surface image and a primary-display image to overlap, the surface image being displayed on a substantial entirety of a surface of a cylindrical screen that extends in parallel with a specified axis, the primary-display image being displayed to look as if the primary-display image were situated in an internal space of the screen.
